(19) United States
(12) Patent Application Publication
(10) Pub. No.: US 2023/0420660 A1
(43) Pub. Date: Dec. 28, 2023

(54) SILICON-BASED ANODE MATERIAL AND PREPARATION METHOD THEREOF

(71) Applicant: Guangdong Kaijin New Energy Technology Co., Ltd., Dongguan (CN)

(72) Inventors: Yonglong Wang, Dongguan (CN); Rusheng Fu, Dongguan (CN); Dexin Yu, Dongguan (CN); Yunlin Yang, Dongguan (CN)

(21) Appl. No.: 18/367,469

(22) Filed: Sep. 13, 2023

(30) Foreign Application Priority Data
Oct. 25, 2022 (CN) 202211316163.1

(51) Int. Cl. H01M 4/36; C01B 33/32; H01M 4/38; H01M 4/48; H01M 4/60; H01M 4/583

(52) U.S. Cl. CPC H01M 4/366; C01B 33/325; H01M 4/386; H01M 4/483; H01M 4/602; H01M 4/583; C01P 2006/40; C01P 2004/86; C01P 2004/61; C01P 2004/64; C01P 2002/72; H01M 2004/021

(57) ABSTRACT

A silicon-based anode material and a preparation method thereof are provided. The silicon-based anode material includes a silicon-based core and a coating layer, the silicon-based core includes nano silicon and a lithium-containing silicon oxide, and the coating layer at least includes a polymer layer with —Si—O—Si— bonds. The preparation method of a silicon-based anode material includes (I) preparing a silicon-based core; and (II) coating a polymer layer. The silicon-based anode material includes high initial Coulombic efficiency and initial lithium intercalation capacity. The polymer layer with —Si—O—Si— bonds in the coating layer is insoluble in water, which avoid problems such as slurry sedimentation and poor coating performance, making the silicon-based anode material have good processing performance.

### CROSS-REFERENCE TO RELATED APPLICATION

The present application claims priority from Chinese Patent Application No. 202211316163.1 filed on Oct. 25, 2022, the contents of which are incorporated herein by reference in their entirety.

### FIELD OF THE INVENTION

The invention relates to the field of material preparation technology, in particular to a silicon-based anode material and a preparation method of the silicon-based anode material.

### BACKGROUND OF THE INVENTION

With the development of the economy and social progress, electric tools play an important role in human life, and secondary batteries have become an irreplaceable core in the electric tools. With people's pursuit of larger capacity and lighter weight on the secondary batteries, existing secondary battery technology can no longer satisfy the rapidly growing demands, such as a longer mileage of electric vehicles, a lighter weight of intelligent wearable devices, and so on. The core of the above problems lies in the practical problem of low energy density of the existing secondary battery.

At present, graphite anode materials as anode materials for secondary batteries are most widely used in commerce, which have a theoretical capacity per gram of only 372 mAh/g. The existing technology is extremely close to its theoretical capacity per gram, so it is urgent to develop anode materials with higher capacity per gram. Silicon anode materials have been extensively researched due to their extremely high capacity per gram (theoretical capacity per gram of 4200 mAh/g). In addition, the silicon anode materials are considered as the next generation anode materials due to the advantages such as low lithium deintercalation potential and abundant raw material sources. However, such silicon anode materials have a disadvantage of severe volume expansion (>300%). During the charging and discharging process, particles of the materials prone to be cracked and pulverized after repeated shrinkage and expansion, leading to continuous rupture and regeneration of the SEI layers on the material surface, consuming a large amount of electrolyte and reversible capacity, and resulting in rapid degradation of the cycle performance of the batteries.

In order to solve the huge expansion problem, silicon oxide anode materials have begun to gain attention, for their high capacity per gram (1500 mAh/g to 1800 mAh/g) and low cyclic expansion (<160%). However, due to the large amount of lithium ions consumed by compounds such as lithium silicate formed during the lithium intercalation process, the initial Coulombic efficiency usually does not exceed 75%, becoming the biggest factor which restricts their application. The initial Coulombicic efficiency can be improved to over 85% by a prelithiation to the silicon oxide anode, which brings adverse effects on the material processing however. For example, in the process of water system homogenization, compounds such as lithium silicate on the surface are easily dissolved in water, while internal nano silicon is prone to react with water, producing gases and increasing the pH of the slurry system, disrupting the equilibrium state of the slurry system and causing slurry sedimentation. At the same time, pinholes and uneven coating are also prone to occur during the coating process.

Therefore, it's an urgent problem to improve the gas production behavior during the prelithiation of the silicon oxide anode materials and enhance the processing performance in the art.

### SUMMARY OF THE INVENTION

In view of above issues, purposes of the invention are to provide a silicon-based anode material and a preparation method of the silicon-based anode material. The silicon-based anode material of the invention has high reversible capacity and initial Coulombic efficiency, and has the advantages of stable aqueous slurry and excellent processing performance; especially gas production is inhibited at high temperatures, to maintain sufficient stability during the homogenization process.

To achieve the above objectives, a first aspect of the invention provides a silicon-based anode material including a silicon-based core and a coating layer. The silicon-based core includes nano silicon and a lithium-containing silicon oxide, and the coating layer at least including a polymer layer with —Si—O—Si— bonds.

The silicon-based core of the invention includes nano silicon and a lithium-containing silicon oxide. The coating layer at least includes a polymer layer with —Si—O—Si— bonds, which is insoluble in water, thereby preventing the reaction of nano silicon in the silicon-based core with water to produce gas, as well as avoiding problems such as slurry sedimentation and poor coating performance, and making the silicon-based anode material have good processing performance.

In some embodiments, a median particle size of the silicon-based anode material is 2 μm to 15 μm.

In some embodiments, a grain size of the nano silicon is less than or equal to 20 nm.

In some embodiments, the lithium-containing silicon oxide includes Li₂SiO₃ or a mixture of Li₂SiO₃ and Li₂Si₂O₅.

In some embodiments, the coating layer is the polymer layer with —Si—O—Si— bonds.

In some embodiments, the coating layer includes a carbon coating layer and the polymer layer with —Si—O—Si— bonds, and both the polymer layer and the carbon coating layer are coated on a surface of the silicon-based core.

In some embodiments, the coating layer includes a carbon coating layer and the polymer layer with —Si—O—Si— bonds, and the polymer layer is between the carbon coating layer and the silicon-based core.

In some embodiments, the coating layer includes a carbon coating layer and the polymer layer with —Si—O—Si— bonds, and the carbon coating layer is between the polymer layer and the silicon-based core.

In some embodiments, a thickness of the carbon coating layer is 5 nm to 300 nm.

In some embodiments, the carbon coating layer accounts for 0.5% to 20% of a sum of mass of the silicon-based core and the coating layer.

In some embodiments, a thickness of the polymer layer is 2 nm to 50 nm.

In some embodiments, the polymer layer accounts for 0.1% to 10% of sum of mass of the silicon-based core and the coating layer.

A second aspect of the invention provides a preparation method of a silicon-based anode material, including Steps (I) and (II):
(I) preparing a silicon-based core: mixing a silicon-based material and a lithium source, and conducting a heat treatment, with the silicon-based material being SiOₓ or carbon-coated SiOₓ, and 0.5≤x≤1.6;
(II) coating a polymer layer: preparing a hydrogen releasing agent aqueous dispersion, adding the silicon-based core, and stirring to obtain a mixed liquid, maintaining a pH of the mixed liquid at 10 to 11, adding a film-forming promoter containing silicic acid groups and keeping stirring, then conducting a solid-liquid separation to obtain a solid material, and dispersing the solid material after conducting a heat treatment.

In the preparation method of the silicon-based anode material of the present invention, in Step (I), the silicon-based material reacts with the lithium source for heating treatment, which can prelithiate the silicon oxide in the silicon-based material to generate a lithium-containing silicon oxide to obtain a silicon-based anode material with high reversible capacity and improved initial Coulombic efficiency. In Step (II), the silicon-based core is added to the hydrogen releasing agent aqueous dispersion, and the lithium-containing silicon oxide will be dissolved in the aqueous solution to form silicate ions; the film-forming promoter can maintain sufficient silicate ions in the solution, multiple silicic acids and multiple silicate ions can be dehydrated and polycondensed at pH of 10 to 11 to form a large number of polymers with —Si—O—Si— bonds, which can be further polycondensed by heat treatment to form a three-dimensional network polymer layer. The prepared silicon-based anode material can effectively avoid the gas production behavior and have good processing performance.

In some embodiments, the lithium source includes at least one of alkyl lithium, metallic lithium, lithium aluminum hydride, lithium amide, lithium carbide, lithium silicide, and lithium borohydride.

In some embodiments, the lithium source accounts for 2% to 25% of mass of the silicon-based material.

In some embodiments, a temperature of the heat treatment in Step (I) is 300° C. to 1000° C.

In some embodiments, time of the heat treatment in Step (I) is 1 h to 10 h.

In some embodiments, the heat treatment in Step (I) is conducted in a vacuum or non oxidizing atmosphere, and the non oxidizing atmosphere is at least one of hydrogen atmosphere, nitrogen atmosphere, helium atmosphere, neon atmosphere, argon atmosphere, krypton atmosphere and xenon atmosphere;

In some embodiments, the method further includes washing with water and conducting a drying treatment after the heat treatment in Step (I).

In some embodiments, the solid-liquid separation is centrifugation, suction filtration, or pressure filtration.

In some embodiments, a temperature of the heat treatment in Step (II) in coating a polymer layer is 40° C. to 800° C.

In some embodiments, time of the heat treatment in Step (II) is 5 h to 60 h.

In some embodiments, the heat treatment in Step (II) is conducted in a vacuum or non oxidizing atmosphere, and the non oxidizing atmosphere is at least one of hydrogen atmosphere, nitrogen atmosphere, helium atmosphere, neon atmosphere, argon atmosphere, krypton atmosphere and xenon atmosphere.

In some embodiments, a heating rate of the heat treatment in Step (II) being 0.5° C./min to 5° C./min.

In some embodiments, the hydrogen releasing agent aqueous dispersion is prepared by dispersing a hydrogen releasing agent in a solvent, and the hydrogen releasing agent includes at least one of the silicon phosphate, silicon tripolyphosphate, magnesium phosphate, calcium phosphate, and magnesium carbonate.

In some embodiments, the hydrogen releasing agent aqueous dispersion is prepared by dispersing a hydrogen releasing agent in a solvent, and a pH of the mixed liquid is adjusted at 10 to 11 by the solvent.

In some embodiments, the film-forming promoter includes at least one of silica sol, potassium silicate, sodium silicate, ammonium silicate, sodium methyl silicate, and potassium methyl silicate.

In some embodiments, the film-forming promoter accounts for 0.1% to 1% of mass of the silicon-based core.

In some embodiments, a mass ratio of the solid material to a liquid material in the mixed liquid is 1:1 to 1:5.

In some embodiments, a device used for the stirring is a magnetic stirrer, a rotary stirrer, a turbine stirrer or a helical ribbon mixer.

In some embodiments, time of the keeping stirring is 0.5 h to 12 h.

In some embodiments, the dispersing includes breaking and sieving.

The invention also provides a use of the silicon-based anode materials in anode materials. Such silicon-based anode materials as anode active materials can meet the high energy density requirements of electric tools.

### BRIEF DESCRIPTION OF THE DRAWINGS

The accompanying drawings facilitate an understanding of the various embodiments of this invention. In such drawings:

FIG. 1 is an XRD (X-Ray Diffraction) pattern of the silicon-based anode material prepared in Embodiment 1 according to the present invention;

FIG. 2 shows gas production condition of the slurry in Embodiment 1 at room temperature for 268 h; and

FIG. 3 shows gas production condition of the slurry in Comparative Example 1 at room temperature for 2 h.

### DETAILED DESCRIPTION OF ILLUSTRATED EMBODIMENTS

The silicon-based anode material of the invention may be used as an anode active material in secondary batteries. It may be used alone as an anode active material, or mixed with other anode active materials (such as natural graphite, artificial graphite, soft carbon and or hard carbon, etc.).

The silicon-based anode material of present invention includes a silicon-based core and a coating layer. A median particle size of the silicon-based anode material is 2 μm to 15 μm. As examples, the median particle size of the silicon-based anode material may be, but not limited to, 2 μm, 2.5 μm, 3 μm, 4.5 μm, 4.9 μm, 5.2 μm, 6.3 μm, 6.7 μm, 8.2 μm, 10 μm, 12 μm, or 15 μm. In some embodiments, the median particle size may be 4 μm to 9 μm.

The silicon-based core includes nano silicon and a lithium-containing silicon oxide. A grain size of the nano silicon is less than or equal to 20 nm. As examples, the grain size of the nano silicon may be, but not limited to 20 nm, 18 nm, 16 nm, 14 nm, 12 nm, 10 nm, 8 nm, 6 nm, or 5 nm. In some embodiments, the grain size of the nano silicon is less than or equal to 10 nm. In some embodiments, the small grain size of nano silicon can prevent the material from severe expansion to be pulverized, thereby effectively ensuring the cycle stability. The lithium-containing silicon oxide includes Li₂SiO₃ or a mixture of Li₂SiO₃ and Li₂Si₂O₅. Generally, there may be Li₂SiO₃ in majority after lithiation, as Li₂Si₂O₅ is easily converted to Li₂SiO₃. In practice, the content and specific components of the lithium-containing silicon oxide in the silicon-based cores are affected by the degree of prelithiation. In some embodiments, the lithium-containing silicon oxide is Li₂SiO₃ or a mixture of Li₂SiO₃ and Li₂Si₂O₅.

The coating layer of the silicon-based anode material in the present invention may be in various forms.

As the first embodiment, the coating layer is a polymer layer with —Si—O—Si— bonds, that is, silicic acids and silicate ions are dehydrated and polycondensed on the surface of the silica-based core to form a polymer layer with —Si—O—Si— bonds and a three-dimensional network structure.

In some embodiments, the surface of the silicon-based core is provided with a carbon coating before polymer coating, and the resulting coating layer of the silicon-based anode material includes a carbon coating layer and a polymer layer with —Si—O—Si— bonds. The surface of the silicon-based core may be completely coated with carbon, or partially coated without carbon at some areas (such as ≤50%, ≤40%, ≤30%, ≤20%, ≤10%, ≤5%, ≤3%, or ≤1% of the area).

As the second embodiment, the coating layer includes a carbon coating layer and a polymer layer with —Si—O—Si— bond, and both the polymer layer and the carbon coating layer are coated on the surface of the silicon-based core. For this form, the carbon coating layer is not completely coated on the silicon-based core, so the polymer layer is coated on the surface area of the silicon-based core that is not covered by the carbon coating layer. Optionally, the carbon coating layer is coated on at least 10%, at least 20%, at least 30%, at least 40%, at least 50%, at least 60%, at least 70%, at least 80%, at least 90%, at least 93%, at least 95%, at least 97%, at least 99% of the surface of the silicon-based core, so as to inhibit the expansion of the silicon-based core.

As the third embodiment, in the preparation of the silicon-based anode material, after the silicon-based core is added to the hydrogen releasing agent aqueous dispersion, the solution will infiltrate the carbon coating layer and slowly pass through the carbon coating layer to contact the lithium-containing silicon oxide, and then the lithium-containing silicon oxide will be dissolve, diffused through the carbon coating layer to the solution, and polymerized with the silicic acid, then polycondensed on the surface of the carbon coating layer to form a three-layer structure of silicon-based core—carbon coating layer—polymer layer. At this time, the coating layer includes a carbon coating layer and a polymer layer with —Si—O—Si— bonds, and the carbon coating layer is between the polymer layer and the silicon-based core.

As the fourth embodiment, after the silicon-based core is added to the hydrogen releasing agent aqueous dispersion and soaked for a certain period of time, the dissolution of the lithium-containing silicon oxide is large enough. At this time, the carbon coating layer and the silicon-based core are separated to generate void space therebetween. That is to say, the carbon coating layer is not tightly attached to the silicon-based core, and the dissolved lithium-containing silicon oxide begins to be polymerized in the void space between the silicon-based core and the carbon coating layer, to form a three-layer structure of silicon-based core—polymer layer—carbon coating layer. That is, the coating layer includes a carbon coating layer and a polymer layer with —Si—O—Si— bond, and the polymer layer is between the carbon coating layer and the silicon-based core. Alternatively, a four-layer structure of silicon-based core—polymer layer—carbon coating layer—polymer layer also may be formed.

Of course, in the actual practice, the coating layer of silicon-based anode electrode material is not limited to the above forms, which may be a combination of various forms. For example, when the carbon coating is not completely coated on the silicon-base core, the polymer layer may exist on the surface of the silicon-based core uncoated with carbon and the outer surface of the carbon coating layer. Alternatively, the polymer layer may exist on the surface of a carbon-uncoated silicon-based core, the outer surface and the inner surface of the carbon coating layer. Alternatively, the polymer layer may exist on the surface of the carbon-uncoated silicon-based core and the inner surface of the carbon coating layer. On the other hand, for example, when the carbon coating is completely coated on the silicon-based core, the polymer layer may exist on both the outer surface and inner surfaces of the carbon coating layer. The coating forms of the silicon-based anode material may be affected by many factors, such as coating condition, binding force and porosity of the carbon coating layer, and soaking time of the silicon-based core in solution. However, regardless of the coating form, the coating layer at least including a polymer layer with —Si—O—Si— bond can inhibit gas production, thereby maintaining sufficient stability of the silicon-based anode material in the homogenizing process.

As an embodiment, a thickness of the carbon coating layer of the invention is 5 nm to 300 nm. The thickness of the carbon coating layer may be, but not limited to, 5 nm, 10 nm, 20 nm, 50 nm, 100 nm, 150 nm, 200 nm, 250 nm, or 300 nm. In some embodiments, the thickness of the carbon coating is 20 nm to 100 nm.

As an embodiment, the carbon coating layer of the invention accounts for 0.5% to 20% of a sum of mass of the silicon-based core and the coating layer. The mass of the carbon coating may specifically account for, but not be limited to, 0.5%, 1%, 2%, 2.5%, 5%, 6%, 7%, 8%, 9%, 10%, 12%, 15%, or 20%. In some embodiments, the mass of the carbon coating accounts for 1% to 10%.

As an embodiment, a thickness of the polymer layer of the invention is 2 nm to 50 nm. The thickness of the polymer layer may be, but not limited to, 2 nm, 5 nm, 10 nm, 15 nm, 20 nm, 25 nm, 30 nm, 35 nm, 40 nm, 45 nm, or 50 nm. In some embodiments, the thickness of the polymer layer is 2 nm to 10 nm.

As an embodiment, the polymer layer accounts for 0.1% to 10% of a sum of mass of the silicon-based core and the coating layer. The mass of the polymer layer may specifically account for, but not be limited to, 0.1%, 0.2%, 0.5%, 1%, 2%, 3%, 4%, 5%, 6%, 7%, 8%, 9%, or 10%.

In some embodiments, the mass of the polymer layer accounts for 1% to 3%.

A preparation method of a silicon-based anode material in the present invention includes:

(I) Preparing a Silicon-Based Core:

mixing a silicon-based material and a lithium source, and conducting a heat treatment, the silicon-based material being SiOₓ or carbon-coated SiOₓ, and 0.5≤x≤1.6;

(II) Coating a Polymer Layer:

preparing a hydrogen releasing agent aqueous dispersion and adding the silicon-based core to stir to obtain a mixed liquid, maintaining a pH of the mixed liquid at 10 to 11, adding a film-forming promoter containing silicic acid groups and keeping stirring, then conducting a solid-liquid separation to obtain a solid material, and dispersing the solid material after conducting a heat treatment.

It's generally considered that SiOₓ is referred to dispersing nano silicon in silicon oxide, where x may be specifically, but not limited to, 0.5, 0.6, 0.7, 0.8, 0.9, 1.0, 1.1, 1.2, 1.3, 1.4, 1.5, or 1.6. In some embodiments, 0.7≤x≤1.2.

The carbon-coated SiOₓ as a silicon-based material used for prelithiation is beneficial to the proceeding of the prelithiation. In the prelithiation process, a liquid-like prelithium agent will flow along the carbon coating layer and infiltrate the carbon coating layer. In addition, heat will be released during the melting process of the prelithium agent, and carbon coating is preferred to avoid the rapid growth of nano silicon grains in the region. The carbon-coated SiOₓ may be coated by conventional means.

As an embodiment, the lithium source includes at least one of alkyl lithium, metallic lithium, lithium aluminum hydride, lithium amide, lithium carbide, lithium silicide, and lithium borohydride. The lithium source accounts for 2% to 25% of the mass of the silicon-based material. The mass of the lithium source may specifically account for, but not be limited to, 2%, 5%, 7%, 9%, 10%, 12%, 15%, 17%, 19%, 21%, or 25%.

In some embodiments, the mass of the lithium source accounts for 3% to 15% of the silicon-based material.

As an embodiment, a temperature of the heat treatment is 300° C. to 1000° C. The temperature of heat treatment may be, but not limited to, 300° C., 450° C., 550° C., 600° C., 700° C., 800° C., 900° C., or 1000° C. In some embodiments, the temperature of the heat treatment is 500° C. to 800° C. The time of the heat treatment time is 1 h to 10 h. As examples, the time of heat treatment may be 1 h, 2 h, 2.5 h, 3 h, 4 h, 5 h, 6 h, 7 h, 8 h, 9 h, or 10 h. In some embodiments, the temperature of the heat treatment is 3 h to 7 h. The heat treatment is carried out in a vacuum or non-oxidizing atmosphere, and the non-oxidizing atmosphere is at least one of hydrogen atmospheres, nitrogen atmosphere, helium atmosphere, neon atmosphere, argon atmosphere, krypton atmosphere and xenon atmosphere.

As an embodiment, the method further includes washing with water and conducting a drying treatment, so as to remove excess substances from the surface of the material. A drying temperature is 40° C. to 150° C. As examples, the drying temperature may be, but not limited to, 40° C., 60° C., 80° C., 100° C., 120° C., 140° C., or 150° C. In some embodiments, the drying temperature is 40° C. to 100° C. A drying time is 6 h to 48 h, and specifically may be, but not limited to, 6 h, 12 h, 18 h, 24 h, 30 h, 36 h, 42 h, 46 h, or 48 h. In some embodiments, the drying temperature is 6 h to 24 h.

In coating a polymer layer of Step (II), the hydrogen releasing agent aqueous dispersion is prepared by dispersing a hydrogen releasing agent in a solvent.

As an embodiment, the hydrogen releasing agent includes at least one of silicon phosphate, silicon tripolyphosphate, magnesium phosphate, calcium phosphate and magnesium carbonate. As an example, the hydrogen releasing agent is silicon phosphate or silicon tripolyphosphate. The hydrogen releasing agent accounts for 0.1% to 10% of the mass of the silicon-based core. The mass of hydrogen releasing agent may be, but not limited to, 0.1%, 0.2%, 0.5%, 1%, 2%, 3%, 4%, 5%, 6%, 7%, 8%, 9%, or 10%. In some embodiments, the mass of the hydrogen releasing agent accounts for 1% to 3%. The hydrogen releasing agent has low mass and has no side reaction with the silicon-based core, thus the silicon-based core can maintain its original characteristics of high capacity and high initial Coulombic effect. In the case of selecting the above material as the hydrogen releasing agent, the material can be slowly hydrolyzed and release H+, and a single silicate in the system can be transformed into silicic acid under the action of the released H+. The silicic acid reacts with the silicic acid to form a dimer which is then recombined with H⁺to react with a single silicic acid to form a trimer, thus generating a silicate multimer continuously, which is finally formed to a three-dimensional network structure with —Si—O—Si—bonds in the subsequent heat treatment. The hydrogen releasing agent is granular, and its particle size is reduced to the nanometer level by sanding, grinding, etc., such as 100 nm, 200 nm, 300 nm, 400 nm, or 500 nm. As an example, the particle size of the hydrogen releasing agent D50 is smaller than 200 nm.

As an embodiment, the solvent is a weak acid buffer solution of, a weak alkaline buffer solution, or its mixed solution with water or alcohol. A pH of the mixed liquid is adjusted to 10 to 11 by the solvent, such as 10.0, 10.1, 10.2, 10.3, 10.4, 10.5, 10.6, 10.7, 10.8, 10.9, or 11.0. By adjusting the pH of the mixed liquid to 10 to 11 by the solvent, the silicates can exist in the system in the form of multimers rather than dimers, which are finally formed to a three-dimensional network structure with —Si—O—Si—bonds in the subsequent heat treatment.

As an embodiment, the film-forming promoter includes at least one of the silica sol, potassium silicate, sodium silicate, ammonium silicate, sodium methyl silicate, and potassium methyl silicate. As a film-forming promoter, the above materials are water-soluble and may provide silicic acid groups in the solution system. As an example, the film-forming promoter is silica sol. The film-forming promoter accounts for 0.1% to 1% of the mass of the silicon-based core, which may be, but not limited to, 0.1%, 0.2%, 0.3%, 0.4%, 0.5%, 0.6%, 0.7%, 0.8%, 0.9%, or 1%.

As an embodiment, the equipment used for the stirring may be a magnetic stirrer, a rotary stirrer, a turbine stirrer or a helical ribbon mixer. As an embodiment, the time of the keeping stirring is 0.5 h to 12 h, which may be, but not limited to, 0.5 h, 1 h, 2 h, 3 h, 4 h, 5 h, 6 h, 7 h, 8 h, 9 h, 10 h, 11 h, or 12 h. Under aqueous conditions, the silicon-based core has high activity, and the lithium-containing silicon oxide on the surface thereof has a quick dissolution, as a result, a large of lithium-containing silicon oxides will be dissolved under long-time stirring, which results in gas production due to the reaction of nano-silicon with water.

As an embodiment, the mass ratio of the solid material to the liquid material in the mixed liquid is 1:1 to 1:5. As an example, the solid material to the liquid material in the mixed liquid is 1:1 to 1:2. A smaller amount of liquid material (i.e., solvent) facilitates to increase the concentration of the silicic acid and the silicate in the system, which is conducive to the polycondensation reaction. The solid-liquid separation may be centrifugation, suction filtration, or pressure filtration.

In coating a polymer layer of Step (II), the solid material obtained from the solid-liquid separation is performed with a heat treatment in order to dry the solid material and remove water. In addition, the heat treatment is performed under a certain temperature and atmosphere, which facilitates to a further reaction between the silicic acid multimers to generate dehydration and condensation to finally form a polymer film with three-dimensional structure. As an embodiment, the temperature of the heat treatment is 40° C. to 800° C., which may be, but not limited to, 40° C., 60° C., 80° C., 100° C., 200° C., 300° C., 40° C., 500° C., 600° C., 700° C., or 800° C. In some embodiments, the temperature of the heat treatment is 60° C. to 500° C. The time of the heat treatment is 5 h to 60 h, which may be, but not limited to, 5 h, 6 h, 8 h, 10 h, 12 h, 20 h, 24 h, 30 h, 36 h, 40 h, 48 h, 53 h, or 60 h. In some embodiments, the time of the heat treatment is 6 h to 24 h. The heating rate of heat treatment is 0.5° C./min to 5° C./min, which may be, but not limited to, 0.5° C./min, 1.0° C./min, 2° C./min, 3° C./min, 4° C./min, or 5° C./min. In some embodiments, the heating rate of the heat treatment is 1.0° C./min to 1.5° C./min. The heat treatment is carried out in a vacuum or non-oxidizing atmosphere, and the non-oxidizing atmosphere is at least one of the hydrogen atmosphere, nitrogen atmosphere, helium atmosphere, neon atmosphere, argon atmosphere, krypton atmosphere and xenon atmosphere.

As an embodiment, the dispersing includes breaking and sieving. A dispersing device has a line speed of 5 m/s to 10 m/s to prevent the formed polymer film from being destroyed. A 400-mesh sieve may be used in sieving.

In order to better explain the purpose, technical solution and beneficial effect of the invention, the invention will be further explained in combination with specific embodiments. It should be noted that the method described below is a further explanation of the invention and should not be taken as a limitation of the invention.

### Embodiment 1

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 16.7 g of 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

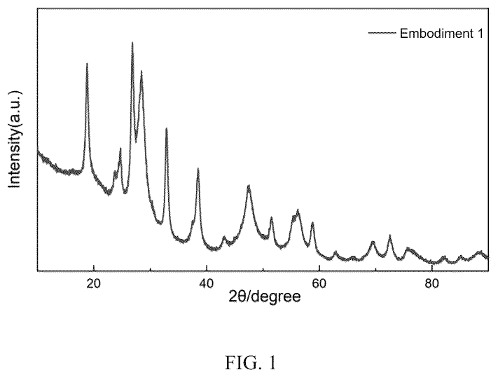

The median particle size of the prepared silicon-based anode material is 6 μm. As observed by FTIR (Fourier Transform Infrared Spectroscopy) combined with SEM (Scanning Electron Microscope), and as shown in XRD pattern of FIG. 1, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 2

The present embodiment is a preparation method for a silicon-based anode material, including the following steps:
(I) Preparing a Silicon-Based Core:
mixing carbon-coated SiOₓ (completely coated with a carbon coating layer with a thickness of 40 nm, and the carbon coating layer accounting for 2.5% of the mass of carbon-coated SiOₓ, where x is 0.8) with metal Li (accounting for 10.5% of the mass of carbon-coated SiOₓ), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 1.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid; maintaining a pH of the mixed liquid at 10.7, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 12 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 5 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 3

The present embodiment is a preparation method for a silicon-based anode material, including the following steps:
(I) Preparing a Silicon-Based Core:
mixing carbon-coated SiOₓ (completely coated with a carbon coating layer with a thickness of 60 nm, and the carbon coating layer accounting for 3.5% of the mass of carbon-coated SiOₓ, where x is 1.2) with metal Li (accounting for 10.5% of the mass of carbon-coated SiOₓ), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 1.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, and maintaining a pH of the mixed liquid at 10.6, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 4

The present embodiment is a preparation method for a silicon-based anode material, including the following steps:
(I) Preparing a Silicon-Based Core:
mixing carbon-coated SiOₓ (completely coated with a carbon coating layer with a thickness of 50 nm, and the carbon coating layer accounting for 3.0% of the mass of carbon-coated SiOₓ, where x is 0.9) with metal Li (accounting for 10.5% of the mass of carbon-coated SiOₓ), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 1.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid; maintaining a pH of the mixed liquid at 10.5, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 400° C. for 4 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 7 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 5

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon phosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid; maintaining a pH of the mixed liquid at 10.5, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 10 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 6

The present embodiment is a preparation method for a silicon-based anode material, including the following steps:
(I) Preparing a Silicon-Based Core:
mixing carbon-coated SiO (completely coated with a carbon coating layer with a thickness of 80 nm, and the carbon coating layer accounting for 5.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of magnesium phosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 16.7 g of 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 7

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core; (II) Coating a Polymer Layer:
weighing 2.0 kg of alkaline buffer solution of sodium carbonate—sodium hydroxide (0.025 mol/L), adding 10 g of magnesium carbonate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 8

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of calcium phosphate, and mixing and stirring at a 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 16.7 g 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 9

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon tripolyphosphate, and mixing and stirring at a of 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 5 g of potassium silicate, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 10

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, maintaining a pH of the mixed liquid at 10.5, then adding 5 g of methyl sodium silicate, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 11

The present embodiment is a preparation method for a silicon-based anode material, including the following steps:
(I) Preparing a Silicon-Based Core:
mixing carbon-coated SiO (completely coated with a carbon coating layer with a thickness of 100 nm, and the carbon coating layer accounting for 4.0% of the mass of carbon-coated SiO) with lithium borohydride (accounting for 25% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 1.5 kg of alkaline buffer solution of sodium carbonate—sodium hydroxide (0.025 mol/L), adding 5 g of silicon tripolyphosphate, and mixing and stirring at 500 rpm/min for 10 min, to prepare a hydrogen releasing agent aqueous dispersion, and then adding 0.8 kg of silicon-based core, stirring at 500 rpm/min for 60 min to form a mixed liquid, maintaining a pH of the mixed liquid at 10.6, then adding 20 g of 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

### Embodiment 12

The present embodiment is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 860° C. for 2 h, with a heating rate of 3° C./min; after the reaction, washing the mixed material with water, with a mass ratio of the mixed material to water being 1:2, then removing the water by centrifugation, and placing the wet mixed material in a drying oven at 80° C. to obtain a silicon-based core;
(II) Coating a Polymer Layer:
weighing 2.0 kg of alkaline buffer solution of sodium carbonate—sodium hydroxide (0.025 mol/L), adding 10 g of silicon tripolyphosphate, and mixing and stirring at 700 rpm/min for 15 min, to prepare a hydrogen releasing agent aqueous dispersion, and then adding 0.9 kg of silicon-based core, stirring at 700 rpm/min for 60 min to form a mixed liquid, maintaining a pH of the mixed liquid at 10.5, then adding 16.7 g of 20 wt % silica sol, with the mass ratio of a solid material to a liquid material in the mixed liquid being 1:1, keeping stirring for 30 min, and then carrying out press filtration to obtain a solid material; then placing the solid material in a blast drying oven of a vacuum atmosphere of 60° C. for 24 h, with a heating rate of 2.5° C./min; after natural cooling, dispersing the solid material by using a dispersing device at a linear speed of 5 m/s and sieving through a 400-mesh sieve to obtain a silicon-based anode material. Note that, a rotary stirrer is used for the above stirring.

The median particle size of the prepared silicon-based anode material is 6 μm. As observed by FTIR combined with SEM, the silicon-based anode material includes a silicon-based core and a coating layer. The silicon-based core is composed of nano-silicon, Li₂SiO₃ and Li₂Si₂O₅, and the coating layer includes a carbon coating layer and a polymer layer with —Si—O—Si— bonds.

The silicon-based anode materials prepared in Embodiments 1 to 12 were respectively tested by infrared spectroscopy. The powder samples were mixed with quantitative KBr in a certain proportion by KBr pellet, grinded under an infrared lamp, and tableted with 600 Kgf/cm² for about 1 min. The silicon-based anode materials prepared has strong antisymmetric stretching vibration absorption peak of —Si—O—Si-bonds at 1095 cm⁻¹ and symmetric stretching vibration absorption peak of —Si—O—Si-bonds at 800 cm⁻¹.

### Comparative Example 1

The present example is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon-based core, stirring at 500 rpm/min for 60 min to form a mixed liquid, maintaining a pH of the mixed liquid at 10.5, then adding 16.7 g of 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

As observed by FTIR combined with SEM, the silicon-based anode material prepared in Comparative Example 1 has no polymer layer or —Si—O—Si— bonds.

### Comparative Example 2

The present example is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of deionized water, adding 10 g of silicon tripolyphosphate, and stirring at 500 rpm/min for 10 min to prepare a hydrogen releasing agent aqueous dispersion, and then adding 1.0 kg of silicon-based core, stirring at 500 rpm/min for 60 min to form a mixed liquid at a pH of 12; then adding 16.7 g of 30 wt % silica sol, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

Comparative Example 2 has no polymerization occurred. As observed by FTIR combined with SEM, the silicon-based anode material prepared has no polymer layer or —Si—O—Si— bonds.

### Comparative Example 3

The present example is a preparation method for a silicon-based anode material, including the following steps:
(I) Preparing a Silicon-Based Core:
mixing carbon-coated SiO (completely coated with a carbon coating layer with a thickness of 50 nm, and the carbon coating layer accounting for 3.0% of the mass of carbon-coated SiO) with metal Li (accounting for 10.5% of the mass of carbon-coated SiO), and placing in a box furnace in a nitrogen protective atmosphere for heat treatment at 650° C. for 4 h, with a heating rate of 2° C./min; after the reaction, washing the mixed material with water, with a mass ratio of the mixed material to water being 1:3, then removing the water by centrifugation, and placing the wet mixed material in a drying oven at 60° C. to obtain a silicon-based core;
(II) Coating a Polymer Layer:
weighing 2.0 kg of alkaline buffer solution of sodium carbonate—sodium hydroxide (0.025 mol/L), adding 10 g of silicon tripolyphosphate, and mixing and stirring at 500 rpm/min for 10 min, to prepare a hydrogen releasing agent aqueous dispersion, and then adding 1.0 kg of silicon-based core, stirring at 500 rpm/min for 60 min to form a mixed liquid, and maintaining a pH of the mixed liquid at 10.5, with the mass ratio of a solid material to a liquid material in the mixed liquid being 1:3, keeping stirring for 30 min, and then carrying out press filtration to obtain a solid material; then placing the solid material in a blast drying oven of a vacuum atmosphere of 60° C. for 24 h, with a heating rate of 1.5° C./min; after natural cooling, dispersing the solid material by using a dispersing device at a linear speed of 7 m/s and sieving through a 400-mesh sieve to obtain a silicon-based anode material. Note that, a rotary stirrer is used for the above stirring.

After detected, the network structure of the polymer layer of the silicon-based anode material prepared in Comparative Example 3 was found to be incomplete.

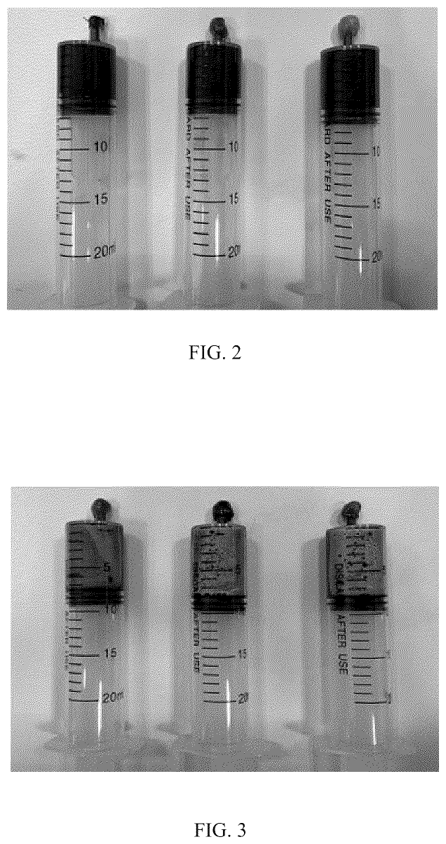

The silicon based anode materials prepared in Embodiments 1 to 12 and Comparative Examples 1 to 3 were respectively tested for electrochemical performance and gas production, with the following test conditions and test results shown in Table 1. Moreover, the gas production of the slurry in Embodiment 1 at room temperature for 268 h is shown in FIG. 2, while the gas production of the slurry in Comparative Example 1 at room temperature for 2 h is shown in FIG. 3.

Electrochemical performance test: the silicon-based anode materials prepared in Embodiments 1 to 12 and Comparative Examples 1 to 3 were used as active materials to be mixed with a binder, namely an aqueous dispersion of an acrylonitrile multipolymer (LA132, solid content 15%), and a conductive agent (Super-P) according to a mass ratio of 70:10:20, a proper amount of water was added to be used as a solvent to prepare a slurry, and the slurry was smeared on a copper foil, dried in vacuum and rolled to prepare anodes. With lithium metal as a counter electrode, CR2032 button batteries were assembled in a glove box filled with an inert gas with polypropylene microporous membranes as membranes, by means of 1 mol/L of an electrolyte which was a LiPF6 three-component mixed solvent mixed according to EC:DMC:EMC=1:1:1(v/v). The charge-discharge performance of the button batteries was tested by means of a battery test system of LANHE. Specifically, under a normal temperature, the button batteries were discharged to 0.01 V at a constant current of 0.1 C, then further discharged to 0.005 V at a constant current of 0.02 C, and finally charged to 1.5 V at a constant current of 0.1 C. A capacity of the button battery charged to 1.5V is called as an initial lithium intercalation capacity, and a ratio of a charging capacity to a discharge capacity is called as an initial Coulombic efficiency.

Gas production test: 5 ml of the slurry in the electrochemical performance test was put into a 20 ml of a syringe, and the front end of the syringe was sealed by hot melt adhesive; then the sealed syringes with slurry were respectively stored at room temperature and in the oven at 45° C., and the movements of the syringes were observed. A difference between the time when the syringe started to move and the time when the test started was recorded as gas production time of the material.

TABLE 1
results of electrochemical performance test and gas production
in each Embodiment and each Comparative Example

| | Initial lithium | Initial | Gas | Gas |
|---|---|---|---|---|
| | intercalation | Coulombic | production | production |
| | capacity/ | efficiency/ | time at | time at |
| | mAh | % | 25° C./h | 45° C./h |
| Embodiment 1 | 1550.4 | 90.27 | 268 | 72 |
| Embodiment 2 | 1552.2 | 90.43 | 256 | 76 |
| Embodiment 3 | 1551.5 | 90.31 | 260 | 80 |
| Embodiment 4 | 1548.5 | 90.29 | 260 | 96 |
| Embodiment 5 | 1549.9 | 90.36 | 252 | 53 |
| Embodiment 6 | 1552.4 | 90.33 | 248 | 52 |
| Embodiment 7 | 1549.3 | 90.36 | 240 | 57 |
| Embodiment 8 | 1550.7 | 90.33 | 246 | 52 |
| Embodiment 9 | 1548.9 | 90.22 | 196 | 40 |
| Embodiment 10 | 1550.6 | 90.28 | 204 | 41 |
| Embodiment 11 | 1650.1 | 89.09 | 276 | 88 |
| Embodiment 12 | 1553.5 | 90.30 | 246 | 50 |
| Comparative | 1565.4 | 90.25 | ≤2 | ≤0.5 |
| Example 1 | | | | |
| Comparative | 1566.7 | 90.10 | ≤2 | ≤0.5 |
| Example 2 | | | | |
| Comparative | 1561.6 | 90.22 | ≤2 | ≤0.5 |
| Example 3 | | | | |

It's seen from the results of Table 1 that, the silicon-based anode materials prepared in all Embodiments 1 to 12 and Comparative Examples 1 to 3 have high initial lithium intercalation capacity and initial Coulombic efficiency. Compared with Comparative Examples 1 to 3, the silicon-based anode materials prepared in Embodiments 1 to 12 can effectively inhibit gas production. Moreover, in the silicon-based anode materials prepared in Embodiments 1 to 12, multiple silicic acids and multiple silicate ions can be dehydrated and polycondensed at pH of 10 to 11 to form a large number of polymers with —Si—O—Si— bonds, which can be further polycondensed by heat treatment to form a three-dimensional network polymer layer.

In Comparative Example 1, no polymer layer with —Si—o—Si— bonds was formed since there was no hydrogen releasing agent to promote the conversion of silicate ions into silicic acid for polycondensation. It' seen from the comparison between FIG. 2 and FIG. 3, the silicon-based anode materials prepared in Embodiment 1 had no gas production at room temperature for 268 h, while the silicon-based anode materials prepared in Comparative Example 1 had a gas production up to 3 mL at room temperature for 2 h.

The mixed liquid in Comparative Example 2 had a pH of 12, which leads to a poor inhibition effect on gas production.

Comparative Example 3 had no film-forming promoter, which leads to a poor inhibition effect on gas production.

Finally, it should be noted that the above embodiments are only used to illustrate the technical solution of the invention and not to limit the scope of protection of the invention. Although the invention is described in detail with reference to the preferable embodiments, it is not limited to those listed in the embodiments. Within the scope of knowledge possessed by a person ordinarily skilled in the art, various modifications or changes can be made without departing from the essence and scope of the present invention.

What is claimed is:

1. A silicon-based anode material, comprising a silicon-based core and a coating layer, the silicon-based core comprising nano silicon and a lithium-containing silicon oxide, and the coating layer at least comprising a polymer layer with —Si—O—Si— bonds.

2. The silicon-based anode material according to claim 1, wherein a median particle size of the silicon-based anode material is 2 μm to 15 μm.

3. The silicon-based anode material according to claim 1, wherein a grain size of the nano silicon is less than or equal to 20 nm.

4. The silicon-based anode material according to claim 1, wherein the lithium-containing silicon oxide comprises Li₂SiO₃ or a mixture of Li₂SiO₃ and Li₂Si₂O₅.

5. The silicon-based anode material according to claim 1, wherein the coating layer is the polymer layer with —Si—O—Si— bonds.

6. The silicon-based anode material according to claim 1, wherein the coating layer comprises a carbon coating layer and the polymer layer with —Si—O—Si— bonds, and both the polymer layer and the carbon coating layer are coated on a surface of the silicon-based core.

7. The silicon-based anode material according to claim 1, wherein the coating layer comprises a carbon coating layer and the polymer layer with —Si—O—Si— bonds, and the polymer layer is between the carbon coating layer and the silicon-based core.

8. The silicon-based anode material according to claim 1, wherein the coating layer comprises a carbon coating layer and the polymer layer with —Si—O—Si— bonds, and the carbon coating layer is between the polymer layer and the silicon-based core.

9. The silicon-based anode material according to claim 6, wherein a thickness of the carbon coating layer is 5 nm to 300 nm.

10. The silicon-based anode material according to claim 6, wherein the carbon coating layer accounts for 0.5% to 20% of a sum of mass of the silicon-based core and the coating layer.

11. The silicon-based anode material according to claim 6, wherein a thickness of the polymer layer is 2 nm to 50 nm.

12. The silicon-based anode material according to claim 6, wherein the polymer layer accounts for 0.1% to 10% of a sum of mass of the silicon-based core and the coating layer.

13. A preparation method of a silicon-based anode material, comprising steps of:
(I) preparing a silicon-based core:
mixing a silicon-based material and a lithium source, and conducting a heat treatment, the silicon-based material being SiOₓ or carbon-coated SiOₓ, and 0.5≤x≤1.6;
(II) coating a polymer layer:
preparing a hydrogen releasing agent aqueous dispersion, adding the silicon-based core, and stirring to obtain a mixed liquid, maintaining a pH of the mixed liquid at 10 to 11, adding a film-forming promoter containing silicic acid groups and keeping stirring, then conducting a solid-liquid separation to obtain a solid material, and dispersing the solid material after conducting a heat treatment.

14. The preparation method of a silicon-based anode material according to claim 13, wherein the lithium source comprises at least one of alkyl lithium, metallic lithium, lithium aluminum hydride, lithium amide, lithium carbide, lithium silicide, and lithium borohydride.

15. The preparation method of a silicon-based anode material according to claim 13, wherein a temperature of the heat treatment in step (I) is 300° C. to 1000° C.

16. The preparation method of a silicon-based anode material according to claim 13, wherein a temperature of the heat treatment in step (II) is 40° C. to 800° C.

17. The preparation method of a silicon-based anode material according to claim 13, wherein the hydrogen releasing agent aqueous dispersion is prepared by dispersing a hydrogen releasing agent in a solvent, and the hydrogen releasing agent comprises at least one of the silicon phosphate, silicon tripolyphosphate, magnesium phosphate, calcium phosphate, and magnesium carbonate.

18. The preparation method of a silicon-based anode material according to claim 13, wherein the hydrogen releasing agent aqueous dispersion is prepared by dispersing a hydrogen releasing agent in a solvent, and a pH of the mixed liquid is adjusted at 10 to 11 by the solvent.

19. The preparation method of a silicon-based anode material according to claim 13, wherein the film-forming promoter comprises at least one of silica sol, potassium silicate, sodium silicate, ammonium silicate, sodium methyl silicate, and potassium methyl silicate.

20. The preparation method of a silicon-based anode material according to claim 13, wherein the film-forming promoter accounts for 0.1% to 1% of mass of the silicon-based core.
